(19) United States
(12) Patent Application Publication
(10) Pub. No.: US 2025/0041717 A1
(43) Pub. Date: Feb. 6, 2025

(54) REAL-TIME GENERATION OF ASSISTIVE CONTENT

(71) Applicant: SONY INTERACTIVE ENTERTAINMENT INC., Tokyo (JP)

(72) Inventors: Vijaya Munjeti, San Mateo, CA (US); Ritagya Meharishi, San Mateo, CA (US); Olga Rudi, San Mateo, CA (US); Elizabeth Osborne, San Mateo, CA (US); Bethany Tinklenberg, San Mateo, CA (US)

(21) Appl. No.: 18/230,578

(22) Filed: Aug. 4, 2023

(51) Int. Cl. A63F 13/422; A63F 13/45; A63F 13/573; A63F 13/63; A63F 13/87

(52) U.S. Cl. CPC A63F 13/422; A63F 13/45; A63F 13/573; A63F 13/63; A63F 13/87

(57) ABSTRACT

Systems and methods for real-time generation of assistive content are provided. Gameplay data, such as activity files or object files, may be stored in association with user-generated content including media files. Based on gameplay data from different sessions, a learning model may be trained to identify patterns that correlate types of gameplay data (e.g., regarding in-game actions) to game outcomes. A current interactive session may be monitored to identify player actions. The learning model may be applied to make predictions regarding likelihood of success based on current trajectory and to identify recommendations for next actions correlated with successful or otherwise desired outcomes. Media files such as video files and related content may be used to generate custom assistive content to present to the user. Such assistive content may be presented in real-time within the same or different window or display associated with the user.

### BACKGROUND OF THE INVENTION

### 1. Field of the Invention

The present invention generally relates to content generation. More specifically, the present invention relates to real-time generation of assistive content.

### 2. Description of the Related Art

Presently available digital interactive content titles may include audio-visual, interactive (e.g., game), and other types of data presented in association with a virtual environment. Playing such digital content (e.g., game titles and other interactive content titles associated with virtual environments) may involve using one or more user devices to generate a virtual environment display and navigate within the virtual environment during an interactive or play session. Different interactive content titles may include different rules that define and govern predetermined objectives, as well as different options for how to achieve the same. For example, some interactive content titles may include virtual competitions among different players or characters (including computer-controlled or artificial intelligence-controlled characters) that may race, fight, or otherwise compete in demonstrations of one or more virtual skills in the associated virtual environment. Other game titles may entail use of a virtual character or avatar—which may also operate within a multiplayer team—to act within certain storylines to achieve a quest or mission objective.

Different players, especially new or beginning players unfamiliar with a certain content title, may find it difficult to achieve one or more objectives of an interactive content title and become frustrated, which may lead to reduced engagement. While instructional content may be available for a content title (e.g., online manuals or video walkthroughs), however, such instructions may be generic rather than tailored to a particular player's characteristics, preferences, and challenges in achieving a particular objective in a particular content title. Moreover, pausing a gameplay session to search for useful instructional content or seek out other players for advice may also interrupt the player's flow, concentration, and participation, which may further disrupt the session for other player(s) participating the session as well.

There is, therefore, a need in the art for improved systems and methods of real-time generation of assistive content.

### SUMMARY OF THE CLAIMED INVENTION

Embodiments of the present invention include systems and methods for real-time generation of assistive content. Gameplay data, such as activity files or object files, may be stored in association with user-generated content including media files. Based on gameplay data from different sessions, a learning model may be trained to identify patterns that correlate types of gameplay data (e.g., regarding in-game actions) to game outcomes. A current interactive session may be monitored to identify player actions. The learning model may be applied to make predictions regarding likelihood of success based on current trajectory and to identify recommendations for next actions correlated with successful or otherwise desired outcomes. Media files such as video files and related content may be used to generate custom assistive content to present to the user. Such assistive content may be presented in real-time within the same or different window or display associated with the user.

### BRIEF DESCRIPTION OF THE DRAWINGS

FIG. 1 illustrates an exemplary network environment in which a system for real-time generation of assistive content may be implemented.

FIG. 2 illustrates a recorder that may record user-generated content for used in generating assistive content in real-time.

FIG. 3 illustrates an exemplary implementation of a system for real-time generation of assistive content.

FIG. 4 illustrates an exemplary virtual environment and associated user interfaces for presenting assistive content generated in real-time.

FIG. 5 illustrates an alternative implementation of a system for real-time generation of assistive content.

FIG. 6 is a flowchart illustrating an exemplary method for real-time generation of assistive content.

FIG. 7 is a schematic block diagram of an example neural network architecture 900 that may be used with one or more embodiments described herein.

FIG. 8 is a flowchart illustrating an exemplary method for real-time generation of assistive content that is tailored to a user.

FIG. 9 illustrates an exemplary electronic entertainment system that may be used in embodiments of the present invention.

### DETAILED DESCRIPTION

Embodiments of the present invention include systems and methods for real-time generation of assistive content. Gameplay data, such as activity files or object files, may be stored in association with user-generated content including media files. Based on gameplay data from different sessions, a learning model may be trained to identify patterns that correlate types of gameplay data (e.g., regarding in-game actions) to game outcomes. A current interactive session may be monitored to identify player actions. The learning model may be applied to make predictions regarding likelihood of success based on current trajectory and to identify recommendations for next actions correlated with successful or otherwise desired outcomes. Media files such as video files and related content may be used to generate custom assistive content to present to the user. Such assistive content may be presented in real-time within the same or different window or display associated with the user.

Gameplay data that is generated after presentation of the real-time assistive content may be tracked to identify player progression in relation to one or more gameplay objectives throughout a gameplay session of a game title. The gameplay objectives associated with the game title may be defined under the rules of the game. For example, gameplay objectives may correspond to reaching certain levels within the virtual environment of the game title, achieving a certain number of points or other recognition, performing better in relation to other players or characters (e.g., winning a race, fight), and other metrics or statuses under the rules of the game title. In some implementations, bots may be programmed to play through one or more game titles or interactive content titles in accordance with different combinations and variations of gameplay actions in order to generate gameplay data and related data files for analysis and use in generating custom content.

In addition, learning models may be constructed and trained to correlate-positively or negatively-certain player actions to gameplay trajectories leading to predicted outcomes. Such learning model may be applied to gameplay information associated with the current gameplay session in relation to an objective, which may result in one or more identified gameplay trajectories that include different action options and associated outcomes. The outcomes in each trajectory may further be predicted to lead to different levels of success. One or more actions associated with successful outcomes may be selected and used to generate a recommendation.

In addition, user-generated content (UGC) associated with the recommendations may be compiled into custom assistive content to present to a player as they learn how to achieve gameplay-related objective. The real-time assistive content may include hint information, step-by-step instructions, video of successful actions (and unsuccessful actions), tutorials, practice session options, etc., for display to the player to help them complete the objective. The hint information can include information related to the one or more recommended actions that, if applied correctly by the player, can be expected to increase a likelihood of the player successfully completing the objective. In some examples, the player may request or otherwise specify how much help or the type of help desired. As such, the hint information related to the recommended actions can be direct (e.g., “Try dodging instead of blocking”) or indirect (e.g., “There may be another skill available to you that can help”).

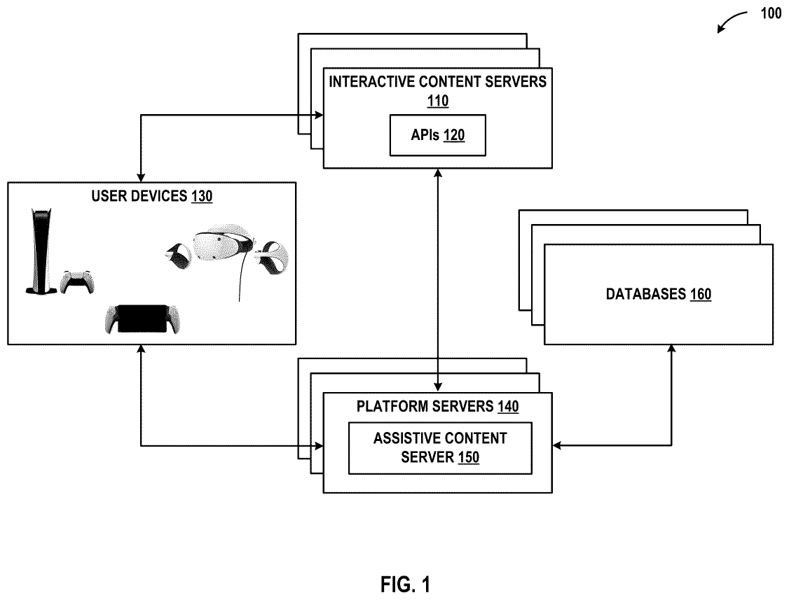

FIG. 1 illustrates an exemplary network environment in which a system for real-time generation of assistive content may be implemented. The network environment 100 may include one or more interactive content servers 110 that provide streaming content (e.g., game titles, other interactive titles, etc.) and APIs 120, one or more user devices 130, one or more platform servers 140 including assistive content server 150, and one or more databases 160. The devices in network environment 100 may communicate with each other using one or more communication networks, which may include a local, proprietary network (e.g., an intranet) and/or may be a part of a larger wide-area network. The communications networks may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. One or more communications networks allow for communication between the various components of network environment 100.

The servers described herein may include any type of server as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

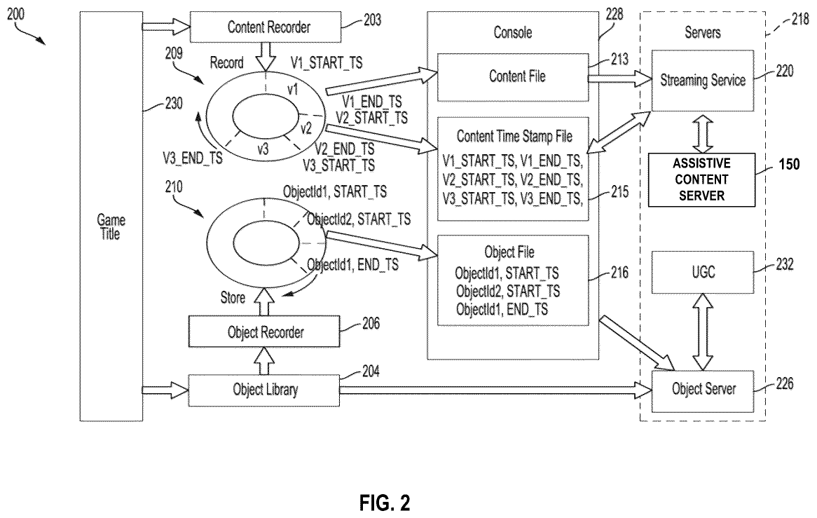

Interactive content servers 110 may maintain, stream, and host a variety of digital content (including interactive media content) and digital services available for distribution over a communication network. Such interactive content servers 110 may be implemented in the cloud (e.g., one or more cloud servers). The interactive content servers 110 may be associated with any content provider that makes its content available for access over a communication network (e.g., for streaming or download). The interactive content servers 110 may therefore host a variety of different content titles, which may further have be associated with activity data files or object data files regarding activities and digital or virtual objects in the virtual environment. Such data files may include activity information, zone information, character information, player information, other game media information, metadata, etc.) associated with the in-game activity or object in the digital or virtual environment during an interactive session. Each media title hosted by interactive content servers 110 may include one or more sets of object data that may be available for participation with (e.g., viewing or interacting with an activity) by a user. Media or other content regarding the object as shown in the virtual environment during the interactive session may be stored as media files by the interactive content servers 110, user device 130, platform servers 140, assistive content server 150, or databases 160 in an activity or object file, as will be discussed in further detail with respect to FIG. 2.

Such digital content hosted by interactive content servers 110 may include not only digital video and games, but also other types of digital applications and services. Such applications and services may include any variety of different digital content and functionalities that may be provided to user devices 130, including providing and supporting chat and other communication channels. The chat and communication services may be inclusive of voice-based, text-based, and video-based messages. Thus, a user device 130 may participate in a gameplay session concurrent with one or more communication sessions, and the gameplay and communication sessions may be hosted on one or more of the interactive content servers 110.

The digital content (e.g., from interactive content server 110) may be provided to a particular user device 130 using one or more APIs in API store 120, which allows various types of devices in network environment 100 to communicate with each other. The APIs 120 may be specific to the particular operating language, system, platform, protocols, etc., of the interactive content server 110, as well as the user devices 130 and other devices of network environment 100. In a network environment 100 that includes multiple different types of interactive content servers 110 and user devices 130, there may likewise be a corresponding number of APIs 120 that allow for various combinations of formatting, conversion, compression/decompression, and other cross-device and cross-platform communication processes for providing and rendering content and other services to different user devices 130, which may each respectively use different operating systems, protocols, etc., to process and render such content. As such, applications and services in different formats may be made available so as to be compatible with a variety of different user device 130. The API 120 may further include additional information, such as metadata, about the accessed content or service to the user device 130. As described below, the additional information (e.g., object data, metadata) can be usable to provide details about the content or service being provided to the user device 130. In some embodiments, the services provided from the interactive content servers 110 to the user device 130 via the API 120 may include supporting services that are associated with other content or services, such as chat services, ratings, and profiles that are associated with a particular game, team, community, etc. In such cases, the interactive content servers 110 may also communicate with each other via one of the APIs 120.

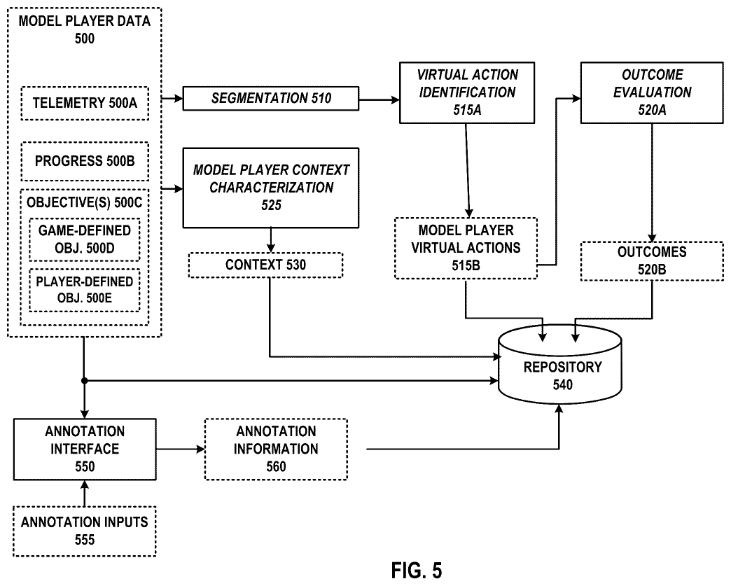

The user device 130 may include a plurality of different types of user devices known in the art. The user device 130 may be a computing device that may include any number of different gaming consoles, display devices, televisions, head-mounted display devices, virtual reality devices, handheld device, mobile devices, laptops, desktops, smart home devices, Internet of Things (IoT) devices, virtual assistant devices, etc. Such user devices 130 may also be configured to access data from other storage media, such as, but not limited to memory cards or disk drives as may be appropriate in the case of downloadable or streaming content. Such user devices 130 may include standard hardware computing components such as, but not limited to network and media interfaces, non-transitory computer-readable storage (memory), and processors for executing instructions that may be stored in memory. These user devices 130 may also run using a variety of different operating systems (e.g., iOS, Android), applications or computing languages (e.g., C++, JavaScript). An exemplary user device 140 is described in detail herein with respect to FIG. 5. Each user device 130 may be associated with one or more participants (e.g., players) or other types (e.g., spectators) of users in relation to a current interactive session.

The platform servers 140 may be responsible for communicating with the different interactive content servers 110, user devices 130, and databases 160 and to provide one or more platform-level services. Such platform servers 140 may be implemented on one or more cloud servers to provide content and services in coordination with interactive content downloaded or streamed by interactive content server 110. For example, the platform servers 140 may support communication sessions, chat sessions, or other social sessions with other players, bots, artificial-intelligence (AI)-based programs, as well as related content such as real-time statistics, scoreboards, news content, trending content, etc.

The platform servers 140 may include an assistive content server 150 configured to provide services related to learning model construction and training in relation to gameplay and associated assistive content, gameplay analysis, and generation of custom assistive content. In exemplary implementations, assistive content server 150 may receive gameplay data regarding a current session from interactive content server 110, user device(s) 130, and/or database(s) 160. Assistive content server 150 may communicate with the other devices to access one or more repositories of gameplay data files regarding the types of virtual actions taken by other players and associated media files that depict the virtual actions taken within the virtual environment. For example, a gameplay activity file may capture the types of particular fighting maneuvers performed by a player in a battle, as well as the resulting win or loss, points achieved, energy or other resources expended, specific inputs used (e.g., button presses, combos, gestures) etc. Associated media files may include recorded audio or video of the battle within the virtual environment and/or of the player during the gameplay session.

Assistive content server 150 may analyze gameplay data files to construct and train a learning model to identify patterns correlating one or more actions with gameplay trajectories leading to specific types of outcomes under certain conditions. The learning model(s) may be used to characterize a current session based on user characteristics and behaviors, virtual objects, elements, events, current gameplay trajectories and outcomes, etc., The trained learning model may further correlate different sets of the identified session characteristics to different gameplay trajectories, in-game actions predicted to lead to certain outcomes, and media file selections. Such learning model may be constructed, trained, and refined using artificial intelligence and machine learning techniques (e.g., similar to those used by large language models trained using large data corpora to learn patterns and make predictions with complex data) applied to historical and current session data, as well as media data and user data.

Assistive content server 150 may apply artificial intelligence and machine learning techniques to train the learning model for a particular user based on session data, including game data, which may be captured during interactive sessions of the same user or different users. Such game data may include not only information regarding the game and other content titles being played, but also user profiles, chat communications (e.g., text, audio, video), captured speech or verbalizations, behavioral data, in-game events, sequences of in-game actions, behaviors, in-game and real-world conditions, etc., associated with the interactive session. The game data may be analyzed to determine whether a media file (or collections or portions thereof) may be useful, engaging, or otherwise suitable to the user. In addition to in-game outcomes, user reactions and comments during or after the presentation of a particular media file (e.g., which may be presented concurrent with a presentation of virtual environment during gameplay), for example, may be used to refine future determinations as to whether the media file should be selected for inclusion in generated assistive content for future sessions.

In some implementations, other data regarding the user (e.g., historical gameplay data, user profiles, user preferences, etc.) may be received from or otherwise discerned in relation to the user, social circles, or other service providers, as well as used as bases for selecting media files to provide or present during or in association with a current interactive session. In addition, game data may be monitored and stored in memory as object or activity files, which may be used for supervised and unsupervised learning whereby a model may be trained to recognize patterns between certain game/user data indicative of gameplay trajectories, as well as to predict actions and decisions that would be helpful or recommended for a particular user. In some implementations, sets of the object files, activity files, or associated media files may be labeled in accordance with any combination of game metadata and user feedback during or in association with gameplay sessions.

In exemplary embodiments, media files, object files, and activity files may provide information to learning models regarding current session conditions, which may also be used for generating recommendations and associated assistive content in real-time with current gameplay. Learning models may therefore use such recorded files to identify specific conditions of the current session, including players, characters, and objects at specific locations and events in the virtual environment. Based on such files, for example, assistive content server 150 may train learning models to identify a relevant media file associated with the content title, virtual environment, virtual scene or in-game event (e.g., significant battles, proximity to breaking records), and recommended actions, which may be used to dynamically generate enriched or otherwise customized assistive content to be presented during or in association with the current session (e.g., during a pause, immediately afterward, or before reset/replay). One or more types of media files may be selected and combined based on recommendations generated by a learning model. The media files may further be customized to the particular preferences and habits of the user.

Such learning model may also be updated by assistive content server 150 based on new feedback or analytics of gameplay and user feedback, which may include language, gestures, and behaviors. Where content and content presentation preferences are being analyzed, the model may further apply pattern recognition to user-associated gameplay and interactive sessions to identify common characteristics and to predict which media file characteristics may be correlated with more positive feedback, more successful gameplay, better or more prolonged user engagement, or other outcome metric. User feedback may indicate certain preferences or ways in which the media files may be selected, modified, and/or presented in a manner best-fitting the needs and preferences of the user. Such user feedback may be used not only to tailor subsequent assistive content for sessions with the specific user, but also for sessions with users identified as sharing similar user attributes. In that regard, the learning model may not only be constructed for or customized to a particular user, but may be used for user groups that share similarities. Further, the assistive content server 150 may affirm such associations or patterns by querying a player for feedback on whether the assistive content was helpful, interesting, or otherwise pleasing to the user and utilize the user feedback to further update and refine the model, as well as monitoring associated or concurrent chat communications and sensor data regarding the user to discern positive or negative reactions.

In some implementations, sensor data associated with user devices 130 may also provide data regarding the surrounding environment (e.g., user facial expressions, speech, physical reactions) or in-game behavioral patterns of the user, which may be used to select or modify media files used to generate assistive content. For example, computer vision analysis on a current display—along with eye-tracking sensors and sensors detecting grip on a controller of user device 130—may be used to determine that a user is intently focused on a particular part of the display of the virtual environment. As such, media files selected for the user in such a situation may include files determined to result in minimal distraction (e.g., audio files and/or select visual media files that are limited to a fraction of the on-screen display). Learning model may also be used to correlate different presentation parameters that may be used by a user device 130 to generate a media file presentation to the user.

The machine learning model may thus be trained to process session data to identify one or more session characteristics that may be positively correlated to certain media files. The identified media files selections and presentation parameters may thus be correlated to predicted possible outcomes of a particular game session. In some embodiments, the media files may be used to generate assistive content, which may include any combination of tutorial content, instructional content, AI-guided instructions, background materials relating to the game title (e.g., character profiles and back stories, storylines, video clips), comparative overlays that analyze successful or unsuccessful actions or decisions, etc. For example, such assistive content may incorporate video of past interactive sessions where a player successfully completed an objective. Alternatively, the assistive content may communicate to the current user that successful players generally perform a certain action at a corresponding point during gameplay or may merely advise that the current user perform the recommended action.

Session data may be captured and stored in activity files that may be provided to machine learning models for analysis as to the current session conditions, e.g., digital content title, what virtual (e.g., in-game) objects, entities, activities, and events that users have engaged with, and thus support analysis of and coordination of assistive content generation, delivery, and synchronization to current virtual interactive and/or in-game activities. Each user interaction within a virtual environment may be associated with the metadata for the type of virtual interaction, location within the virtual environment, and point in time within a virtual world timeline, as well as other players, objects, entities, etc., involved. Thus, metadata can be tracked for any of the variety of user interactions that can occur in during a current interactive session, including associated virtual activities, entities, settings, outcomes, actions, effects, locations, and character stats. Such data may further be aggregated, applied to learning model(s), and subject to analytics to make predictions as to the current interactive session, associated supplemental content, and how to synch or otherwise coordinate presentations across a current device setup and any secondary devices.

For example, various content titles may depict one or more objects (e.g., involved in in-game activities) with which a user can interact, and associated media files may include user-generated content (e.g., screen shots, videos, commentary, mashups, etc.) created by the user, other users/peers, publishers of the media content titles and/or third party publishers as to a particular virtual character, object, or activity of the content title. Such media files may be labeled in accordance with metadata and/or associated gameplay data files by which to search for and filter for applicability to current session characteristics. The media file may also include a deep link (e.g., for directly launching an associated content title at a specific location) to associated objects, events, activities, etc., of the content title or other media files.

Different machine learning m models may be trained using different types of data input, which may be specific to the user, the user demographic, associated game or other interactive content title(s) and genres thereof, social contacts, etc. Using the selected data inputs, therefore, the machine learning model may be trained to identify attributes of a specific user and identify media content parameters that may be specifically relevant to the requesting user (e.g., cartoon-like content for young children, basic instructional content for beginning players, complex diagrams and strategic content for advanced or expert players). Identified session attributes may be associated with a different pattern of in-game behaviors and associated media files. A pattern of certain positive actions or reactions towards a type of media file may reinforce associations with certain players or types of gameplay, for example. For example, certain tutorial content presented during certain game sequences may be strongly correlated with improved gameplay and happy or excited user reactions. Similarly, certain media content (e.g., back story) may be correlated with increased user interest, deeper or more prolonged engagement, or more enthused reactions, etc., in role-playing games as indicated by user speech and behaviors (real-world and in-game/virtual).

Assistive content server 150 may execute instructions to select a set of media files from a repository (e.g., database 160) of available media files based on association with gameplay data matching the characteristics of the current interactive session. Different media files may be geared towards different types of users/players, interactive events, devices, or other session characteristics. A subset of the available supplemental content files may therefore be identified by one or more learning models 160 as being correlated with a particular current interactive session. The selected files may be packaged in accordance with one or more secondary devices associated with a user of the current interactive session. For example, the user may be using one device setup of user devices 140 (e.g., television and game console) to generate a presentation of the virtual environment of a game title, but may further be associated with other available user devices (e.g., another television, laptop, display monitor, mobile device, tablet, IoT device).

The assistive content server 150 may generate assistive content further based on one or more APIs 120 and may further include metadata for synching specific media files (or portions thereof) to specific portions of the current interactive session. For example, a current gameplay session may be predicted to include certain objects, characters, events, etc., that elicit certain actions. A specific media file that includes instructional content related to a predicted action may therefore be synchronized to play (e.g., in an overlay, same or separate window, or on a peripheral device) at a point during the gameplay session in which the action is predicted or recommended.

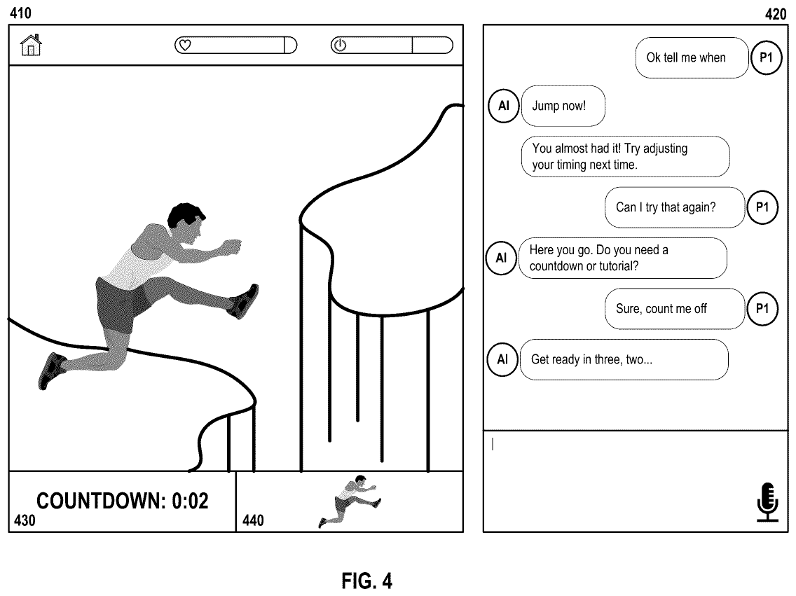

When the player appears to need or want assistance, the assistive content server 150 may thus identify that the player needs assistance, examine player gameplay data, compare the player gameplay data with that of one or more sets of modeled gameplay data, and identify one or more recommended virtual actions that can be taken by the player towards completion of an objective. The assistive content server 150 may further retrieve media files associated with the recommended actions for generation of assistive content. In some cases, the assistive content server 150 may also capture gameplay data for annotation, labeling, and storing at the databases 160 for use in generating assistive content. The assistive content generated in accordance with the recommended virtual actions may be presented to the player as illustrated in FIG. 4.

The databases 160 may be stored on the interactive content servers 110, user devices 130, platform server 140, assistive content server 150, or any of the servers 218 (shown in FIG. 2), on the same server, on different servers, on a single server, across different servers. Such databases 160 may store the media files and/or an associated set of activity or object data files, as well as one or more user profiles. Each user profile may include information about the user (e.g., user progress in an activity and/or media content title, user id, user game characters, etc.).

In an exemplary embodiment of the present invention, platform servers 140 may capture media data files during ongoing gameplay sessions. One current gameplay session may include a user using user device 130 to access and engage with an interactive content title hosted by interactive content servers 110. During gameplay of a particular game title, for example, platform servers 140 may record gameplay data (e.g., regarding in-game status and actions, etc.) sufficient to recreate the gameplay of a current gameplay session in a future gameplay session.

The gameplay data may be retrieved during gameplay to be examined for generation of recommended virtual actions. Gameplay data can be associated with a current gameplay session. The gameplay data may be stored in database(s) 140. In an exemplary implementation, databases 160 may store recorded gameplay data with user devices involved in a gameplay session, which may be linked to a gameplay session. The gameplay data may be recorded in real-time. In some examples, databases 160 may store annotations and/or labels associated with virtual actions and strategies identifiable within the gameplay data.

FIG. 2 illustrates a recorder (e.g., content recorder 203), which may be implemented on the platform servers 120. The content recorder 203 may receive and record content files 213 onto a content ring buffer 209 that can store multiple content segments, which may be stored as a media file (e.g., MP4, WebM, etc.) by the console 228. Such content files 213 may be uploaded to the streaming server 220 for storage and subsequent streaming or use, though the content files 213 may be stored on any server, a cloud server, any console 228, or any user device 130. Such start times and end times for each segment may be stored as a content time stamp file 214 by the console 228. Such content time stamp file 215 may also include a streaming ID, which matches a streaming ID of the media file 212, thereby associating the content time stamp file 214 to the media file 212. Such content time stamp file 215 may be sent to the assistive content server 150 and/or the UGC server 232, though the content time stamp file 215 may be stored on any server, a cloud server, any console 228, or any user device 130.

Concurrent to the content recorder 203 receiving and recording content from the interactive content title 230, an object library 204 receives data from the interactive content title 230, and an object recorder 206 tracks the data to determine when an object begins and ends. The object library 204 and the object recorder 206 may be implemented on the platform servers 140, a cloud server, or on any of the servers 218. When the object recorder 206 detects an object beginning, the object recorder 206 receives object data (e.g., if the object were an activity, user interaction with the activity, activity ID, activity start times, activity end times, activity results, activity types, etc.) from the object library 204 and records the object data onto an object ring-buffer 210 (e.g., ObjectID1, START_TS; ObjectID2, START_TS; ObjectID3, START_TS). Such object data recorded onto the object ring-buffer 210 may be stored in the object file 216. Such object file 216 may also include activity start times, activity end times, an activity ID, activity results, activity types (e.g., tutorial interaction, menu access, competitive match, quest, task, etc.), user or peer data related to the activity. For example, an object file 216 may store data regarding an in-game skill used, an attempt to use a skill, or success or failure rate of using a skill during the activity. Such object file 216 may be stored on the object server 226, though the object file 216 may be stored on any server, a cloud server, any console 228, or any user device 130.

Such object data (e.g., the object file 216) may be associated with the content data (e.g., the media file 212 and/or the content time stamp file 214). In one example, the UGC server 232 stores and associates the content time stamp file 214 with the object file 216 based on a match between the streaming ID of the content time stamp file 214 and a corresponding activity ID of the object file 216. In another example, the object server 226 may store the object file 216 and may receive a query from the UGC server 232 for an object file 216. Such query may be executed by searching for an activity ID of an object file 216 that matches a streaming ID of a content time stamp file 214 transmitted with the query. In yet another example, a query of stored content time stamp files 214 may be executed by matching a start time and end time of a content time stamp file 214 with a start time and end time of a corresponding object file 216 transmitted with the query. Such object file 216 may also be associated with the matched content time stamp file 214 by the UGC server 232, though the association may be performed by any server, a cloud server, any console 228, or any user device 130. In another example, an object file 216 and a content time stamp file 214 may be associated by the console 228 during creation of each file 216, 214. The activity files captured by UDS 200 may be accessed by the platform servers 140 as to the user, the game title, the specific activity being engaged by the user in a game environment of the game title, and similar users, game titles, and in-game activities.

In exemplary embodiments, the media files 212 and activity files 216 may provide information to assistive content server 150 regarding current session conditions, which may be used as the bases for generating assistive content and to train and refine learning models as to the same. Assistive content server 150 may therefore use such media files 212 and activity files 216 to identify specific conditions of the current session, including current actions, events, players, characters, and objects at specific locations within the virtual environment. Based on such files 212 and 216, for example, assistive content server 150 may predict a gameplay trajectory as correlated to the in-game actions or events (e.g., next location within the virtual environment, approaches to or meetups with characters, imminent battles), which may be used to predict actions to take within the current session that would be likely to result in successful outcomes. Session conditions may drive how the gameplay trajectory is assessed, thereby resulting in action recommendations and associated assistive content being generated.

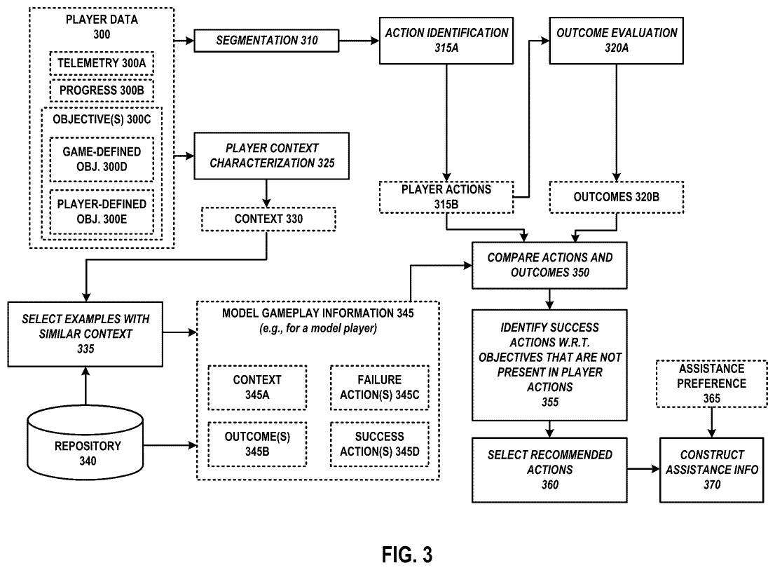

FIG. 3 illustrates an exemplary implementation of a system for real-time generation of assistive content. As illustrated, different data points may be used for analysis of the current session, including applications of machine learning to current session data, in order to generate assistive content that is customized to the user. As a current session is ongoing, however, new session data may be continually received, analyzed, and used to generate updated assistive content. Depending on preferences of the user, custom assistive content may be presented during a pause in the current session, during gameplay in the current session, after the current session, or during a reset or replayed session. Such assistive content may include step-by-step instructions synchronized to current gameplay, as well as analytics or comparison data to other session data from completed sessions played by the current user, other users, or bots.

Player data 300 may be inclusive of any gameplay data associated with a specific player, which can further include telemetry information 300A, status information such as game progress 300B and world state information, such as inputs with respect to time, interactions, execution success (or failure) information. Telemetry information 300A may be used by assistive content server 150 to determine if/when virtual actions have been performed (items used, motions performed when and with what consequences/effects). Other virtual actions may have to be inferred from telemetry (e.g., circling “around”, waiting too long to strike, defensive behavior, making a particular jump to a spot). In some examples, the assistive content server 150 can apply preprocessing steps to extract pertinent information, such as considering telemetry 300A in relation to an enemy (as target can be moving so no two players will always have the same telemetry).

In addition, player data 300 may also include player performance with respect to one or more objectives, which can define conditions for success and may be game-defined 300D and/or player-defined 300E. Game-defined objectives 300D can be defined by rules in game files (fixed or variable) or defined within content from servers (online challenges such as racing tracks). Examples may include getting to a checkpoint location, eliminating an enemy, acquiring currency, getting an item, finishing 3^{rd} place or higher, winning a match, escaping or completing a dungeon, etc.

Player-defined objectives 300E can include any extra goal defined by player (fixed or variable). When selecting or defining player-defined objectives 300E, the player may be prompted to give or select personal goals like challenge runs, or can be used as stepping-stones to the game-defined objective 300D. Some player-defined objectives 300E can be selectable from screen, can be captured/defined using voice and natural language processing, or can be uploaded by other players as user-generated content (e.g., streamer does a challenge run, uploads specifications of challenge, when may then be made available to others). A player-defined objective 300E may include getting to a player-defined location, eliminating an enemy, acquiring currency, getting an item or a specific quantity of items, completing challenge runs (e.g., no death, no upgrades or armor), completing a track with perfect control, performing X amount of drifts lasting X seconds or more, “I want to complete this level 5 times in a row without dying”, “I only want to parry and counter this guy.” Some objectives may be required, optional, or may be weighted as more or less important than others.

Player data 300—which may include data from past sessions, as well as current ongoing sessions—may be subject to segmentation 310, which may result in segments of player data associated with different objectives, periods of gameplay time, levels, milestones, or other conditions within a session. Following segmentation 310, segmented player data may be analyzed in accordance with action identification 315A algorithms and rules to identify specific player actions 315B associated with each segment of player data. The player actions 315B may further be analyzed in accordance with outcome evaluation 320A algorithms and rules to identify specific outcomes 320B. Such outcomes may include actual outcomes observed within the current session and captured in the player data 300, but may also include different predicted outcomes that are possible within the current session.

Meanwhile, player data 300 may have also been subject to player context characterization 325 algorithms and rules, which may identify characteristics associated with the player and their associated gameplay actions, events, environments, objects, etc., within a session. Specific contexts 330 may thus be identified and then correlated to examples with similar context 335. Such examples may have been stored in and retrieved from a repository 340 (which may include databases 160 of FIG. 1). The context 330 and select examples with similar context 335 may be used to train one or more machine learning models 345 to identify patterns and correlations among different modeled contexts 345A, outcome(s) 345B, failure action(s) 345C, and success action(s) 345D. In particular, different outcomes 345B may be associated with different types of actions that have lead up to the respective outcome. Failure actions 345C may include actions that are strongly correlated with failure-type outcomes, and the performance of such failure actions 345C are thus associated with a high probability that the outcome of the session will be a failure. Conversely, success actions 345D may be actions strongly correlated with success-type outcomes, and the performance of such success actions 345D are thus associated with a high probability that the outcome of the session will be a success.

In some examples, assistive content server 150 can apply one or more machine learning models 345 that have been trained to analyze gameplay to current session information. In particular, the model 345 may be used to compare current player actions 315B and possible outcomes 320B. The comparison of actions and outcomes 350 may indicate if/when the player may need help. In some implementations, the player may be able to request assistive content from a menu or other interface, which may be triggered by text, button presses, voice commands, gestures, etc. In some examples, assistive content server 150 may predict that the player may need help based on gameplay information of the player indicating that the player is likely stuck or experiencing frustration. For example, gameplay information from a current session may reveal that the player is repeatedly failing to complete an objective, trying same thing several times to no avail, or doing things predicted to end in failure. Gameplay information may also reveal that the player is performing worse each time, having a lot of idle time, or hesitating. General progress in the game (or lack thereof) can also indicate that the player may need help.

The assistive content server 150 can use the gameplay information to evaluate a performance of the player with respect to the objectives based on conditions that are present or not present in the current session. Such conditions may be include characteristics and actions of the player, as well as characteristics of the virtual environment, other players, characters, events, etc. Based on the evaluation, assistive content server 150 may or may not suggest assistive content for the player. The assistive content server 150 can also predict that the player may need help based on other inputs, such as captured audio or voice chat information. Examples may include situations where the player curses a lot and/or suddenly gets quiet, where tone of voice is identified as indicating frustration and/or resignation, key words/phrases like “what do I do now?” “how do I do this?” “what am I supposed to even do about that??” “why are there two of them?” “this sucks” “this is getting frustrating” “where am I supposed to go?” “I think I'm lost” “I can't figure this puzzle out”, etc.

The assistive content server 150 may also incorporate historical data, such as from a previous session (e.g., where the player tried yesterday and tried again today without much improvement) as accessed from a repository 340. Upon detecting that the player needs help or is actively requesting help, the assistive content server 150 may first ask the player how much help they would like, and can provide assistive content accordingly. Following a comparison 350 of player actions 315B/outcomes 320B with modeled actions 345C-D/outcomes 345B, the assistive content server 150 may identify success actions in relation to a current objective that are not currently present within player actions 315B.

Based on the identified success actions 355, the assistive content server 150 can select recommended actions 360 and/or strategies for helping the player achieve the objective(s). The selection of the recommended actions 360 may occur from among a variety of available actions based on correlation to an outcome that includes achievement or completion of an objective. The assistive content server 150 can maintain or otherwise access a repository 340 having information about how other “model” players have had success or failure with respect to the same or similar objective(s). The information in the repository 340 can include user-generated content, gameplay information for a plurality of sessions, trained learning models (e.g., which may be trained to analyze interactive data associated with different game titles, players, player types, etc.) and can also include labeled strategy information.

To provide assistive content, the assistive content server 150 can identify one or more objectives not sufficiently or consistently met by the player as evidenced within the gameplay information (e.g., telemetry data) of the player. The assistive content server 150 can also identify, based on the gameplay information, one or more “problem areas” that contribute to the one or more objectives not being sufficiently met by the player. For example, if an objective is avoiding detection by designated enemies or opponents, but the gameplay information shows that one or more enemies keep detecting the player, the assistive content server 150 may identify events and inputs associated with detection of the player by the one or more enemies as “problem areas”. The assistive content server 150 may determine, for example, which enemy keeps detecting the player, a position and/or approach path of the player and the enemy upon detection and what events may be attracting the enemy (noise, visual contact).

The assistive content server 150 can access information from the repository 340 that can include model telemetry data from modeled player(s), developer notes, and/or information within the game files that can describe what virtual actions can be taken by the player to avoid the “problem areas”. This can include model telemetry data describing virtual actions that lead to success or failure by the model player(s). Continuing with the example, virtual actions performed by model players leading to success 345D can include, e.g., climbing up on geometry above enemy to drop down from above without detection, hiding in tall grass until enemy turns away from player, moving around enemy just out of line-of-sight, taking out that enemy before attempting to take out others, and/or using items or skills that reduce detection. Virtual actions performed by model players leading to failure 345C can include, e.g., not crouching when standing in tall grass, running straight out in front of enemy leaving player vulnerable to attack, taking out other enemies beforehand leaving player visible, making noise like whistling or stepping on something, not striking at correct time, and/or not staying behind or above the enemy.

The assistive content server 150 can also implement one or more machine learning models 345 that characterize and/or classify virtual actions by the player and model player(s) based on general strategies employed and outcomes achieved. In some examples, classification can go beyond “success/failure” and can also include player characteristics. Further, some actions or sequences can have varying degrees of success or failure, such as when virtual actions may be done successfully but the player (or model player) still fails at some objectives, e.g., a model player may actually die before completing segment, but during that segment they successfully parried an enemy so just that action will be classified as a success for objectives related to successful parries. Further, certain strategies and virtual actions can be pre-defined for a game title. This information can be obtained through code or map analysis, developer notes, and examining what the most successful players do at certain points in the game.

In some examples, the assistive content server 150 can use similarities and differences between gameplay information of player and that of model player(s) to identify, based on comparison, one or more virtual actions 345D that are not being taken by player that are associated with successful completion of the one or more objectives. Similarly, the assistive content server 150 can use similarities and differences between gameplay information of player and that of model player(s) to identify, based on comparison, one or more virtual actions that are being taken by player that are associated with failure 345C to complete the one or more objectives. Aspects that can be used for comparison 350 include but are not limited to: how new or experienced the player is to the game, offense characterization, defense characterization, timing, platforming/traversal habits and skills, general resourcefulness, “build” type, skill level or progress, and player behavior.

The virtual actions identified and examined by the assistive content server 150 can include virtual actions taken by the player (including model players) towards completing the objective(s), successful or not. The assistive content server 150 can include one or more machine learning models 345 operable to examine telemetry data and correlate the telemetry data with the virtual actions and outcomes. In some examples, a virtual action leading to failure 345C can be followed by another action that results in a successful recovery 345B. The “recovery” action may be tagged as dependent upon the first. For example, a virtual action such as a parry or deflection move can be responsive to an enemy attack. Telemetry data can show the player tapping an input combination at a certain time that initiates a parry animation. Telemetry data can also show this virtual action including timing with respect to an enemy attack and timing. The virtual action can have outcomes such as success (deflect attack) or failure (doesn't work, player takes damage). The virtual action can have varying degrees of success, such as in the case of a “partial” parry.

Based on the virtual actions taken by the player and associated outcomes, the assistive content server 150 can identify one or more virtual actions associated with successful completion of objective(s) 345D that are or are not being taken by player. Virtual actions associated with successful completion of objective(s) 345D can be ascertained using information within the repository 340. In some embodiments, this can be achieved by examining similarities and/or differences between gameplay information of player and model player(s) to identify what actions the successful model player(s) have taken for the same objective that the player has not taken. The assistive content server 150 may also consider contextual information such as conditions of virtual actions taken by the player and model player(s) that contribute to success or failure.

Based on the identified virtual actions, the assistive content server 150 can identify a recommended virtual action 360 of the one or more virtual actions for suggestion to the player based on player style, build, and objective(s). For example, the recommended virtual action 360 can include one or more of a timing adjustment, a pathing adjustment, a sequence adjustment, a behavioral adjustment, a build adjustment, getting an item or skill, etc. The assistive content server 150 may recommend that the player use a different input combination. Alternatively, the actions/strategy employed by the player could be good, but the player could simply be actuating too early or too late. Other recommended virtual actions 360 could be directed to traversal (e.g., try going around a structure, try using stealth, try looking in the opposite direction, there are hidden pathways in this room, try finding a way to climb up). Recommended virtual actions can also be related to a status or level of the player, such as being “under-leveled” or having skills that are not suited to the objective. The assistive content server 150 may also recommend that the player retrieve an item or skill, or progress a questline. Other recommended virtual actions 360 could be related to general strategy or attitude of the player, such as “slow down” if the player seems to be rushing, correcting over or under-anticipation, suggesting that the player act more aggressively or defensively, or even recommending that the player take a break.

In some examples, recommended virtual actions 360 may be rated by the player or the assistive content server 150 based on perceived helpfulness. If player feedback or positive outcomes indicate that recommendations 360 generated by assistive content server 150 are helpful, then the assistive content server 150 may continue to make similar recommendations 360 for similar players in the future. Similarly, if player feedback or negative outcomes indicate that recommendations 360 generated by the assistive content server 150 are not helpful, then the assistive content server 150 may adjust future recommendations or avoid making similar recommendations for similar players in the future. This may be part of a continual or periodic training process for one or more machine learning models of the assistive content server 150, e.g., to reinforce good recommendations while avoiding bad recommendations. In some examples, the assistive content server 150 considers preferences, characteristics, and styles of the player when recommending virtual actions 360. As discussed, the assistive content server 150 may provide the player with options to select a level of assistance (e.g., “A lot of help, please” “Only if I'm really struggling” “Don't help me”). The player may also be encouraged to give other preferences, such as those directed to play styles of the player or play styles of friends or other players, spoilers, or level of preparation (e.g., “don't try to warn me ahead of time”).

In some embodiments, the assistive content server 150 can construct a player profile based on the gameplay information associated with the player and will generate assistive content for the player based on the player profile. This can enable the assistive content server 150 to characterize a play style of player and/or play styles of model players to find success and failure examples that are relevant to the player. The player profile can include, for example, one or more player characterization values and one or more player success metrics that respectively describe a play style and relative success of the player with respect to completing objectives. To provide assistive content that is relevant to the player, the assistive content server 150 can use information about one or more model players who demonstrate success or failure with respect to the same or similar objectives, and who may have similar characteristics as the player.

The assistive content server 150 can compare the player characterization values associated with the player with player characterization values associated with the plurality of model players to identify a subset of model players including one or more model players that are similar to the player. In this manner, the assistive content server 150 can ensure that any recommended virtual actions 360 based on the one or more model players are relevant to the player. In some embodiments, the subset of model players can also include, for example, friends of the player or streamers/experts that may be identified by the player. The player characterization values and their formulation may be specific to the game title or series, and/or may be “learned” by a machine learning model 345, which may have access to gameplay information for a plurality of players, including the player and the plurality of model players. In some examples, the player data 300 can be compared with model gameplay information associated with one or more model players to determine or otherwise localize the player characterization values (e.g., if gameplay information is similar to gameplay information of “aggressive” model players regardless of error, then the player may be characterized with values indicating high aggression).

The player success metrics and their formulation may also be specific to the game title or series, and serve to evaluate different aspects of a player's performance during the gameplay session. In some examples, the player success metrics can include evaluation of player performance with respect to objectives met or not met by the player during the gameplay session, evaluation of player performance with respect to information about personal goals of the player (e.g., “I want to be well-rounded”, “I want to parry everything”, “I only want to execute headshots”), and evaluation of player performance with respect to information about success of player relative to previous attempts (e.g., “last 3 times player died before reaching the second phase, but this time they made it to the second phase, so they did something right”).

In some examples, assistive content server 150 can also consider player progress, skills, and inventory when recommending virtual actions 360. For example, if a virtual action involves use of an item or skill that is currently available to the player based on their inventory and ither gameplay information, assistive content server 150 may recommend use of that item or skill. However, if a player has not progressed to a point where they can implement a particular strategy, assistive content server 150 may avoid recommending virtual actions 360 associated with that strategy until the player progresses past that point, and may instead suggest another virtual action or even suggest that the player return later. Conversely, if a strategy such as use of a skill or item is not immediately available to a player, but the gameplay information indicates that the player currently has the ability to obtain the skill or item, then assistive content server 150 may include getting that skill or item as a recommended virtual action 360.

In a further aspect, assistive content server 150 may generate one or more recommended virtual actions 360 to help the player prepare for future challenges based on player progress and operating info. For example, if the player is approaching a challenge that requires a certain skill that the player has not been using, assistive content server 150 can recommend virtual actions 360 that involve use of that skill beforehand, e.g., “You might want to start working on (skill) for upcoming situations”.

Assistive content server 150 can also consider player-defined goals and objectives when generating the recommended virtual actions 360. When setting player-defined objectives, assistive content server 150 may ask the player for information about one or more goals they may have such as “I want to become a well-rounded player” or “I am doing a challenge run”. When generating the recommended virtual actions 360, assistive content server 150 may keep player goals in mind. For example, if the player has a self-imposed constraint or play style preference and it is still possible to complete required objectives under the constraints, assistive content server 150 can recommend virtual actions that can help the player achieve success within the constraints and will avoid recommending virtual actions that violate the constraints.

For example, the player may request help in fighting a particular enemy. Player-defined objectives may indicate a need to learn to parry. For this example, assistive content server 150 may access information from the repository 340 and identify that for this enemy, successful players either: 1) run around in circles waiting for backstab opportunities; or 2) parry enemy attacks and then follow up with a counter-attack. Based on the information within the repository 340, player characteristics, and/or player-set objectives, assistive content server 150 may identify parrying as a recommended virtual action 360 for the player.

As the player attempts to parry the enemy but is unsuccessful, assistive content server 150 may examine player data 300 including telemetry information of the player, game files, and telemetry information of model players 345 who are successful or unsuccessful. Assistive content server 150 may identify, for example, that the player keeps using a first button to continually hold their shield up to block instead of using a second button that allows deflection, and that successful players keep their shield down before initiating the parry animation using the second button. Based on such observations and analyses, assistive content server 150 may identify and display a recommended virtual action 360 that includes making sure their shield is dropped before initiating the parry using the second button.

Assistive content server 150 may continue to watch further attempts using gameplay information of the player, game files, and gameplay information of successful and unsuccessful parries. Assistive content server 150 may identify, for example, that the player is now using the correct input combinations but that their timing is off, e.g., that they are initiating either too early or too late. Assistive content server 150 may identify that successful model players initiate parries within a certain interval after enemy attack starts, and may also identify that the game files define a window for successful parries. Assistive content server 150 may identify a timing adjustment as a recommended virtual action 360, and may suggest to the player that they need to adjust their timing to be within a certain window after the enemy attack starts. Depending on player preferences, assistive content server 150 may give specific timing recommendations, or may generally suggest a timing adjustment if the player prefers to figure it out themselves. If the player continues to fail and appears to be getting frustrated or lose interest, assistive content server 150 may identify an alternative strategy for recommendation to the player. Depending on player preference, assistive content server 150 may temporarily or permanently adjust objectives for performance evaluation accordingly, e.g., to reduce importance of goals associated with parrying in performance evaluation if player decides to try another method instead. However, if the player finds themselves successfully parrying the enemy during later attempts, assistive content server 150 may recognize this and restore or adjust objectives for performance evaluation accordingly.

FIG. 4 illustrates an exemplary virtual environment 410 and associated user interfaces 420-440 for presenting assistive content generated in real-time. A display of virtual environment 410 may be generated during an interactive session when a player uses a player device to perform various virtual actions. Such virtual actions may be represented as being performed by an avatar or character within the display of the virtual environment 410.

In addition to the display of the virtual environment 410, a player device may also present one or more graphical user interfaces used to receive input and/or present other types of content, including assistive content. As illustrated, user interface 420 may include a chat interface through which the player may communicate with a chatbot using text and/or speech. In the illustrated example, the player may be struggling with how to control the avatar in such a way as to perform a successful jump in the virtual environment 410. The chatbot user interface 420 may provide general advice on when and how to make the jump (e.g., “Jump now!” and “Try adjusting your timing”), as well as initiate other related user interfaces 430-440 to display related assistive content. User interface 430 may be a countdown clock to assist the user with how to time the jump, while user interface 440 may be a display of a successful jump (e.g., media from session played by another player or bot). In addition, the instructions from the chatbot or countdown clock may also be presented by way of generated audio played or output in synchronized fashion during gameplay as the player approaches the point where the recommended action is to be performed. In other embodiments, other types of user interfaces may be provided for presenting assistive content, including overlay content, VR or MR content, etc. Differently-sized windows and portions may also be used for the user interfaces 420-440 to present assistive content in accordance with default presets, user preferences, or specific devices being used.

FIG. 5 illustrates an alternative implementation of a system for real-time generation of assistive content. Whereas the implementation of FIG. 3 focused on applying trained machine learning models 345 to player data 300 from a current session, the implementation of FIG. 5 focuses on generating, analyzing, annotating model data that may be used to train the learning models 345. As previously discussed, bots may be programmed to model different player behaviors during play-through sessions of a game title. As such, modelled player data 500 may be generated, including telemetry data 500A, progress data 500B, and objective data 500C including default game-defined objectives 500D and common player-defined objectives 500E. The model player data 500 may similarly be subject to segmentation 510, as well as virtual action identification 515A to identify model player virtual actions 515B and outcome evaluation 520A to identify available or possible outcomes 520A. Model player data 500 may also be subject to model player contact characterization 525 to identify specific context(s) 530. The player virtual actions 515B, available or possible outcomes 520A, and context may be provided to repository 540 for storage.

In addition, assistive content server 150 may also generate an annotation interface 550 in which annotations inputs 555 may be received (e.g., from the player, other players, expert players) and used to annotate parts of the model player data 500. For example, assistive content server 150 may use annotation inputs 555 to label user-generated content illustrating actions by model players with supplemental or instructional content (e.g., “initiate the parry as their weapon is at its apex”). Thus, assistive content may be generated that includes such annotations to provide more detailed instructions to a player. If the player is consistently making the same type of mistake, or if the player keeps failing and asks for more specific information, for example, the assistive content generated by assistive content server 150 may include n instruction about the appropriate interval. During this process, player data 300 of the player may be continually or periodically captured and stored within the repository for generating future recommendations, e.g., as a “model player”. Successful attempts and unsuccessful attempts may be labeled as such based on player outcomes.

To generate recommendations based on player context, behavior and outcomes, assistive content server 150 can capture and maintain the repository that includes success and failure examples for different virtual actions and situations that a player may find themselves in.

As a model player interacts with the virtual environment, assistive content server 150 captures model gameplay information for the model player including telemetry information and other contextual information. The model gameplay information may be segmented based on virtual actions identifiable within the model gameplay information, e.g., into smaller chunks with identifiable actions, progress, etc. The segmenting step may involve application of a machine learning model. Some segments may overlap, others may be sub-segments of larger actions or strategies. Others can be “big picture” segments like a general path taken through an area, a whole bossfight, or a sequence where multiple enemies are taken out.

Assistive content server 150 can characterize or label virtual actions identified within the model gameplay information, which may be performed through application of a machine learning model trained to classify segments of gameplay information. For example, labeled data can convey “this is an example of a successful parry for this type of enemy”, “this is an example of rotating around an enemy”, “this is an example of sneaking up behind”, “this is an example of a drift”, “this is an example of a sequence of gear changes for drag racing”. In some examples, when available, assistive content server 150 may incorporate annotations from model players and experts.

Assistive content server 150 can also evaluate success of a virtual action taken by a model player based on outcomes with respect to game-defined objectives and/or player-defined objectives. This evaluation may be assisted by a machine learning model trained to classify the virtual action based on success or failure. Some virtual actions might not be classified as a binary “success/failure”, and may instead include a general score. In some examples, success or failure of virtual actions taken by model players may be verified by the player (e.g., assistive content server 150 may ask “is this the outcome you wanted?”).

In some embodiments, assistive content server 150 can characterize a play style of the model player based on model gameplay information, progression through the game, and/or a “build” of player, and optionally based on information given by the model player.

When capturing information for a model player, assistive content server 150 may request permission to use the information and may further request annotations from the model player. For example, assistive content server 150 may re-play captured data for review by the model player and the model player may select an option that says, e.g., “yes, include this as an example to help others learn”. For a successful virtual action, the model player may annotate what they did correct (e.g., “initiate the parry a couple of frames after the attack starts”, “stand here and wait for him to attack then turn around and run back towards the door”, “take out the guy with the crossbow before attempting this”). Similarly, for a failed virtual action, the model player may annotate what they did wrong (e.g., “I ran out of heals here”, or “I forgot about the enemy behind me”). Assistive content server 150 may show a replay of segment(s), and can let the model player pause and annotate where they see fit. For example, system can allow the model player (or annotator) to provide visual guidance, e.g., by allowing the player to draw arrows, add text, and the like. In some embodiments, the text may be limited to some pre-defined terms or character limits and can be subject to review and approval. Further, assistive content server 150 can allow the model player (or annotator) to record audio for voice-over annotations that a struggling player can review along with screen recordings of the model player. Annotations may be reviewed for quality, corroborated with those from other successful players, etc. to eliminate unhelpful, profane, or false annotations.

Data for a model player, including screen recordings, gameplay information, characterizations, contextual information and annotations can be labeled and stored in the repository for retrieval and comparison at a later time to help other players. Some players may be identified as “verified experts” so they may have access to additional tools for annotating, their examples may have higher weight when identifying or comparing actions, they may be asked to be used as examples more frequently, they may be asked to review and verify quality of other annotations and examples, they may become play style archetypes, etc. Further, streamers and players with high success rates and lots of play time may be asked to become verified experts.

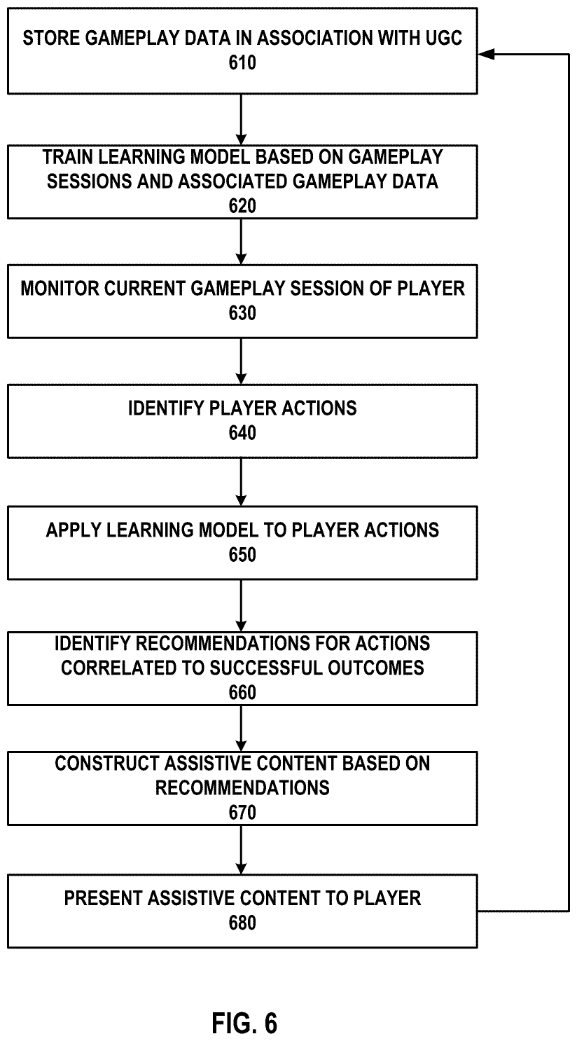

FIG. 6 is a flowchart illustrating an exemplary method 600 for real-time generation of assistive content. In step 610, gameplay data may be stored in memory in association with user-generated content. For example, gameplay data may be captured during gameplay or other interactive sessions and stored within activity files or object files, which may further be associated with media files that are also captured during the gameplay sessions. A player engaged in a car race, for example, may generate data related to the race and use of the car, which are respectively saved in activity files and object files. In addition, media files (e.g., video clips) depicting the virtual environment during the race may also be recorded and saved in database 160 or associated repository of the same.

In step 620, a machine learning model may be trained based on gameplay data from past gameplay session. As discussed herein, the gameplay data may be generated by the same player, different players, or programmed bots, so as to generate different actions under different conditions. Such gameplay data may exhibit patterns that may positively or negatively correlate actions to outcomes. The patterns found in the gameplay data regarding different actions and outcomes under different conditions may therefore be used to train a machine learning model to correlate specific actions to outcomes.

In step 630, a current gameplay session of a player may be monitored by assistive content server 150. The current gameplay session may be initiated when a player device of the player executes an interactive content title (e.g., from memory, downloaded file, streamed content, or otherwise obtained from interactive content server 110). Assistive content server 150 may include the recorder(s) that capture such data in real-time or may access files from storage (e.g., databases 160 or repository 340) in real-time.

In step 640, a current set of player actions may be identified in the current session. As the current session progresses, the player may control an avatar, which may navigate within he virtual environment and perform one or more actions. Some actions may not affect gameplay trajectory in relation to one or more objectives, while other actions may be highly impactful and correlate strongly to success or failure.

In step 650, the trained learning model may be applied to the player actions to identify the current gameplay trajectory and possible actions that are likely to impact available outcomes. For example, the current gameplay trajectory may include traversal through different virtual locations in the virtual environment, encounters with different characters and different possible interactions with the same, different events, etc. There may be multiple different paths, each of which may be associated with different challenges and odds of overcoming the same. Some paths may be easier than others for the user given their specific set of skills, experiences, and strengths.

In step 660, assistive content server 150 may identify recommended actions that are correlated to successful outcomes. Because a gameplay trajectory may diverge and go different possible ways (e.g., towards different outcomes), there may be a number of different actions associated with each segment of the different possible ways. The different actions may each be assessed for strength of correlation to successful outcomes, as well as filtered based on the preferences of the user (e.g., regarding level of difficulty, preferred routes, preferred experiences, characters).

In step 670, assistive content may be generated and constructed by assistive content server 150. Such assistive content may be generated based on user-generated content or other media files associated with the recommended actions. For example, the media files may be filtered based on association with a recommended action. Such media files may therefore depict past sessions in which the recommended action was performed successfully or otherwise resulting in successful outcomes. Multiple different media files may be combined or composited together, supplemented with annotations and/or other instructional content, and otherwise customized for presentation to a particular user (e.g., using a particular user device or device setup).

In step 680, the assistive content may be presented by a user device of a player. Such presentation may occur during a current session or may take place external to the current session. Concurrent presentation of the assistive content may thus be synchronized to the current session so as to be most helpful or useful to the user. For example, step-by-step instructions may be provided at timing points as each step is identified as having been completed successfully. Similarly, a video or overlay of a successful maneuver may be synchronized to current gameplay so as to generate a visual comparison in real-time. As such, the player may be able to determine whether they are performing the correct recommended action and/or otherwise performing the recommended action correctly. As the current gameplay session continues (including continued gameplay actions and associated outcomes), the method may return to step 610 in which activity/object files and associated media files of the current session may be recorded and stored to memory.

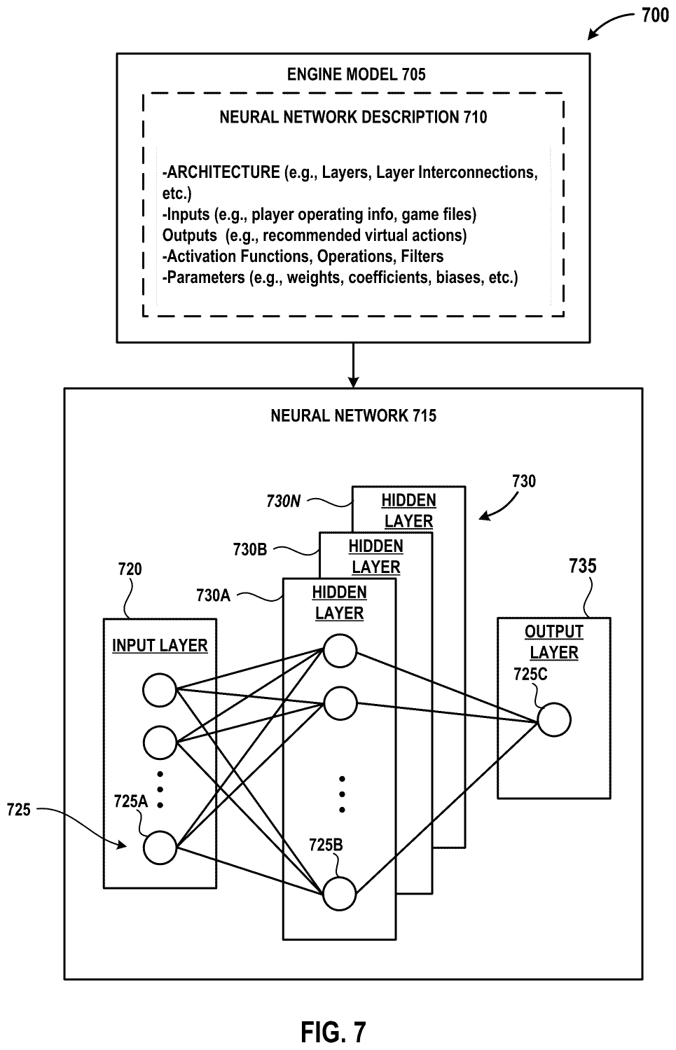

FIG. 7 is a schematic block diagram of an example neural network architecture 700 that may be used with one or more embodiments described herein, e.g., as a component of the assistive content server 125 of FIG. 1 and particularly for identifying one or more recommended virtual actions for the player towards completion of one or more objectives based on gameplay information. In some embodiments, the neural network architecture 700 can be used by the assistive content server 125 to construct, train, apply, and refine machine learning models 345.

Architecture 700 includes a neural network 715 defined by an example neural network description 710 in an engine model (neural controller) 705. The neural network 715 can represent a neural network implementation that may be called upon by assistive content server 150. The neural network description 710 can include a full specification of the neural network 715, including the neural network architecture 700. For example, the neural network description 710 can include a description or specification of the architecture 700 of the neural network 715 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 715 reflects the architecture 700 defined in the neural network description 710. In an example corresponding to machine learning models associated with generating custom assistive content, the neural network 715 includes an input layer 720, which includes input data, such as gameplay information associated with the player (e.g., player data 300), with an individual observed virtual interaction between the player and a virtual gameplay environment corresponding to one or more nodes 725. In one illustrative example, the input layer 720 can include data representing a portion of input media data such as object data captured by object recorder 206 of FIG. 2.

The neural network 715 includes hidden layers 730A through 730N (collectively “730” hereinafter). The hidden layers 730 can include n number of hidden layers, where n is an integer greater than or equal to one. The number of hidden layers can include as many layers as needed for a desired processing outcome and/or rendering intent. The neural network 715 further includes an output layer 735 that provides an output (e.g., recommended virtual action for the player) resulting from the processing performed by the hidden layers 730.

The neural network 715 in this example is a multi-layer neural network of interconnected nodes. Each node can represent a piece of information. Information associated with the nodes is shared among the different layers and each layer retains information as information is processed. In some cases, the neural network 715 can include a feed-forward neural network, in which case there are no feedback connections where outputs of the neural network are fed back into itself. In other cases, the neural network 715 can include a recurrent neural network, which can have loops that allow information to be carried across nodes 725 while reading in input.

Information can be exchanged between nodes through node-to-node interconnections between the various layers. Nodes 725A of the input layer 720 can activate a set of nodes 725B in the first hidden layer 730. For example, as shown, each of the input nodes 725A of the input layer 720 is connected to each of the nodes 725B of the first hidden layer 730. The nodes 725B of the hidden layer 730 can transform the information of each input node 725A by applying activation functions to the information. The information derived from the transformation can then be passed to and can activate the nodes of the next hidden layer (e.g., from hidden layer 730A to 730B), which can perform their own designated functions. Example functions include convolutional, up-sampling, data transformation, pooling, and/or any other suitable functions. The output of the hidden layer (e.g., 730B) can then activate nodes of the next hidden layer (e.g., 704N), and so on. The output of the last hidden layer can activate one or more nodes of the output layer 735, at which point an output is provided. In some cases, while nodes (e.g., nodes 725A-C) in the neural network 715 are shown as having multiple output lines, a node has a single output and all lines shown as being output from a node represent the same output value.

In some cases, each node or interconnection between nodes can have a weight that is a set of parameters derived from training the neural network 715. For example, an interconnection between nodes can represent a piece of information learned about the interconnected nodes. The interconnection can have a numeric weight that can be tuned (e.g., based on a training dataset), allowing the neural network 715 to be adaptive to inputs and able to learn as more data is processed.

The neural network 715 can be pre-trained to process the features from the data in the input layer 720 using the different hidden layers 730 in order to provide the output through the output layer 735. In an example in which the neural network 715 is used to identify recommended virtual action(s) for the player, the neural network 715 can be trained using training data that includes example recommended virtual actions for example players from a training dataset. For instance, training data can be input into the neural network 715, which can be processed by the neural network 715 to generate outputs which can be used to tune one or more aspects of the neural network 715, such as weights, biases, etc.

In some cases, the neural network 715 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 715, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 715 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. The neural network 715 can perform a backward pass by determining which inputs (weights) most contributed to the loss of the neural network 715, and can adjust the weights so that the loss decreases and is eventually minimized.

A derivative of the loss with respect to the weights can be computed to determine the weights that contributed most to the loss of the neural network 715. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 715 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 710 can represent any other neural or deep learning network, such as an autoencoder, a deep belief nets (DBNs), and recurrent neural networks (RNNs), etc.

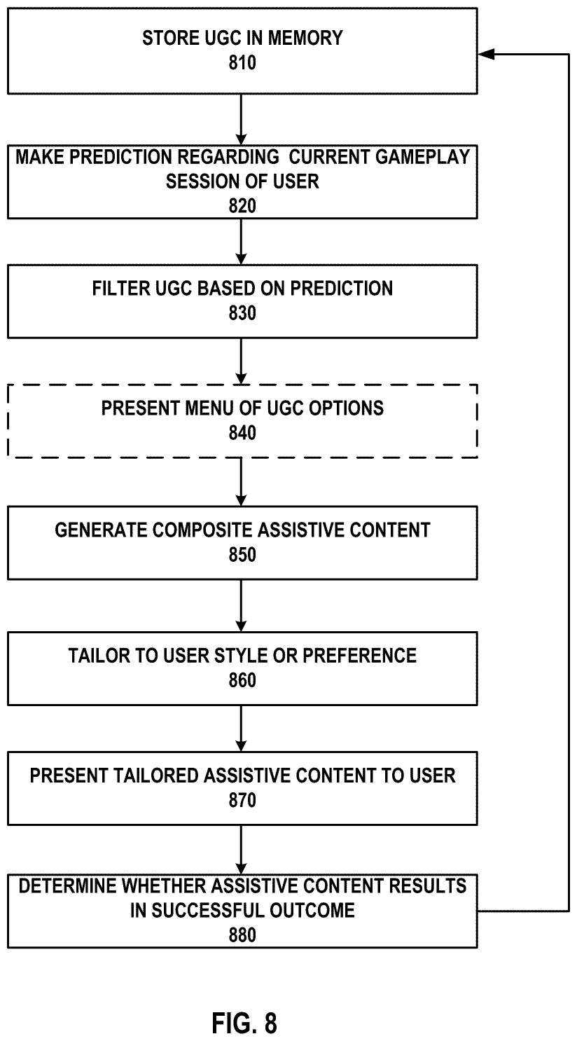

FIG. 8 is a flowchart illustrating an exemplary method 800 for real-time generation of assistive content that is tailored to a user. Step 810 may be similar to step 610 in that user-generated content (media files) may be stored in memory. In step 820, one or more predictions may be generated regarding the current gameplay session of the user. Such predictions may include identifying possible actions in the gameplay trajectory of the current gameplay session and associated outcomes if performed by the user. Different likelihoods of success may also be predicted for each action. For example, different routes within a virtual environment may be predicted lead to encounters with different battle opponents, but one of the opponents may be deemed easier to beat.

In step 830, the user-generated content may be filtered based on the predictions. Different video clips associated with the content title may be filtered to identify as subset illustrating successful battles with an identified opponent. Content filtering may further be based on player characteristics (e.g., similar equipment or skill level), so that the filtered media files may be more relevant to the user.

In step 840, a menu may be generated that includes different options related to presentation of the media files. For example, the assistive content server 150 may query the user for preferences on how much assistive content to provide, what kinds of assistive content to provide, how to present the assistive content, etc. Such queries may include menus or use chatbots and speech generation

In step 850, assistive content sever 150 may generate assistive content based on the filtered files in accordance with any options or preferences selected or indicated by the user. Generating the assistive content may include combining the filtered media files or portions thereof. In some implementations, portions of the filtered files may be composited together, e.g., for visual comparison or for cohesive presentation. Additional content (e.g., text, generated speech, audiovisual) may also be generated to supplement the combined media files. Such additional content may include explanations, instructions, analysis, insights, visual indicators, etc., that may help the user understand the significance of the filtered media files or portions thereof within the assistive content.

In step 860, the assistive content may further be tailored to the user style or preferences. User gameplay style may be discerned from analysis of player data 300. Such user style may be defined based on types of preferred actions (e.g., fight or flight), preferred strategic decisions (e.g., stealth or frontal assault), aggression level, or other characteristics associated with play of the game title. Such style or preferences may also be used to filter media files and/or generate additional content or options for selection by the user.

In step 870, the tailored assistive content may be presented on a user device, and in step 880, it is determined as to whether the presentation of the assistive content results in a successful outcome. The method may then return to step 810, in which data regarding the media files used in generating the presentation and associated outcome may be stored in memory.

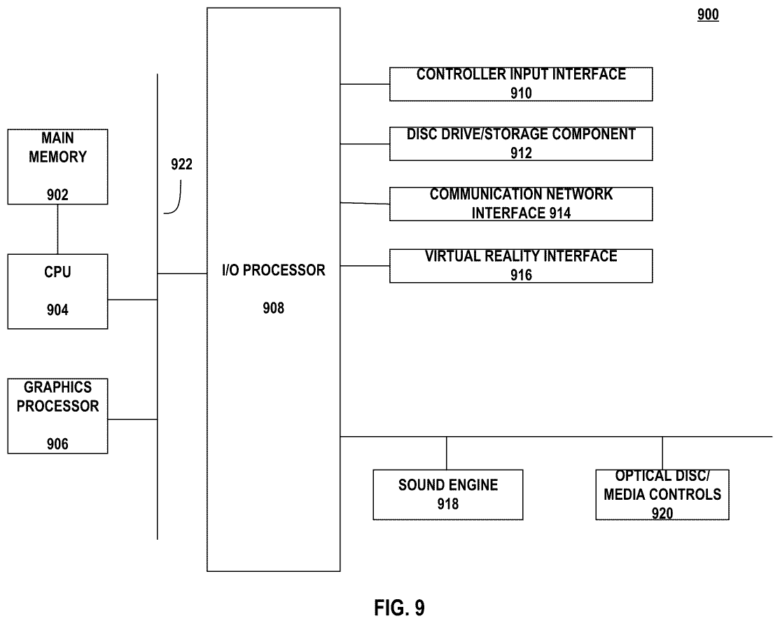

FIG. 9 illustrates a block diagram of an exemplary electronic entertainment system 900 in accordance with an embodiment of the presently disclosed invention. The electronic entertainment system 900 as illustrated in FIG. 9 includes a main memory 902, a central processing unit (CPU) 904, graphic processor 906, an input/output (I/O) processor 908, a controller input interface 910, a hard disc drive or other storage component 912 (which may be removable), a communication network interface 914, a virtual reality interface 916, sound engine 918, and optical disc/media controls 920. Each of the foregoing are connected via one or more system buses 922.

Electronic entertainment system 900 as shown in FIG. 9 may be an electronic game console. The electronic entertainment system 900 may alternatively be implemented as a general-purpose computer, a set-top box, a hand-held game device, a tablet computing device, or a mobile computing device or phone. Electronic entertainment systems may contain some or all of the disclosed components depending on a particular form factor, purpose, or design.

Main memory 902 stores instructions and data for execution by CPU 904. Main memory 902 can store executable code when the electronic entertainment system 900 is in operation. Main memory 902 of FIG. 9 may communicate with CPU 904 via a dedicated bus. Main memory 902 may provide pre-stored programs in addition to programs transferred through the I/O processor 908 from hard disc drive/storage component 912, a DVD or other optical disc (not shown) using the optical disc/media controls 920, or as might be downloaded via communication network interface 914.

The graphics processor 906 of FIG. 9 (or graphics card) executes graphics instructions received from the CPU 904 to produce images for display on a display device (not shown). The graphics processor 906 of FIG. 9 may transform objects from three-dimensional coordinates to two-dimensional coordinates, and vice versa. Graphics processor 906 may use ray tracing to aid in the rendering of light and shadows in a game scene by simulating and tracking individual rays of light produced by a source. Graphics processor 906 may utilize fast boot and load times, 4K-8K resolution, and up to 120 FPS with 120 hz refresh rates. Graphics processor 906 may render or otherwise process images differently for a specific display device.

I/O processor 908 of FIG. 9 may also allow for the exchange of content over a wireless or other communications network (e.g., IEEE 802.x inclusive of Wi-Fi and Ethernet, 9G, 4G, LTE, and 9G mobile networks, and Bluetooth and short-range personal area networks). The I/O processor 908 of FIG. 9 primarily controls data exchanges between the various devices of the electronic entertainment system 900 including the CPU 904, the graphics processor 906, controller interface 910, hard disc drive/storage component 912, communication network interface 914, virtual reality interface 916, sound engine 918, and optical disc/media controls 920.

A user of the electronic entertainment system 900 of FIG. 9 provides instructions via a controller device communicatively coupled to the controller interface 910 to the CPU 904. A variety of different controllers may be used to receive the instructions, including handheld and sensor-based controllers (e.g., for capturing and interpreting eye-tracking-based, voice-based, and gestural commands). Controllers may receive instructions or input from the user, which may then be provided to controller interface 910 and then to CPU 904 for interpretation and execution. The instructions may further be used by the CPU 904 to control other components of electronic entertainment system 900. For example, the user may instruct the CPU 904 to store certain game information on the hard disc drive/storage component 912 or other non-transitory computer-readable storage media. A user may also instruct a character in a game to perform some specified action, which is rendered in conjunction with graphics processor 906, inclusive of audio interpreted by sound engine 918.

Hard disc drive/storage component 912 may include removable or non-removable non-volatile storage medium. Saud medium may be portable and inclusive of digital video disc, Blu-Ray, or USB coupled storage, to input and output data and code to and from the main memory 902. Software for implementing embodiments of the present invention may be stored on such a medium and input to the main memory via the hard disc drive/storage component 912. Software stored on hard disc drive 912 may also be managed by optical disk/media control 920 and/or communications network interface 914.

Communication network interface 914 may allow for communication via various communication networks, including local, proprietary networks and/or larger wide-area networks such as the Internet. The Internet is a broad network of interconnected computers and servers allowing for the transmission and exchange of Internet Protocol (IP) data between users connected through a network service provider. Examples of network service providers include public switched telephone networks, cable or fiber services, digital subscriber lines (DSL) or broadband, and satellite services. Communications network interface allows for communications and content to be exchanged between the various remote devices, including other electronic entertainment systems associated with other users and cloud-based databases, services and servers, and content hosting systems that might provide or facilitate game play and related content.

Virtual reality interface 916 allows for processing and rendering of virtual reality, augmented reality, and mixed reality data. This includes display devices such that might be partial or entirely immersive virtual environments. Virtual reality interface 916 may allow for exchange and presentation of immersive fields of view and foveated rendering in coordination with sounds processed by sound engine 918 and haptic feedback.

Sound engine 918 executes instructions to produce sound signals that are outputted to an audio device such as television speakers, controller speakers, stand-alone speakers, headphones or other head-mounted speakers. Different sets of sounds may be produced for each of the different sound output devices. This may include spatial or three-dimensional audio effects.

Optical disc/media controls 920 may be implemented with a magnetic disk drive or an optical disk drive for storing, managing, and controlling data and instructions for use by CPU 904. Optical disc/media controls 920 may be inclusive of system software (an operating system) for implementing embodiments of the present invention. That system may facilitate loading software into main memory 902.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method for generating assistive content, the method comprising:
receiving user information over a communication network from a user device, the user information regarding one or more interactions in a virtual environment during a current session of an interactive content title;
identifying that one or more of the interactions correspond to a progress level in relation to one or more objectives associated with the interactive content title;
selecting an in-game action from among a plurality of different action options to take next within the virtual environment during the current session based on the progress level, wherein the selected in-game action is predicted to result in an outcome that advances the progress level toward at least one of the objectives;
generating custom assistive content based on the selected in-game action, wherein generating the custom assistive content is based on one or more media files associated with the predicted outcome; and
providing the custom assistive content over the communication network to the user device for presentation during the current session.

2. The method of claim 1, wherein the objectives include one or more of game-defined objectives and one or more player-defined objectives.

3. The method of claim 1, wherein selecting the in-game action includes identifying a current trajectory for the current session based on the progress level, the current trajectory including one or more portions associated with the plurality of different action options in the virtual environment.

4. The method of claim 3, further comprising segmenting at least one of the portions into a plurality of sequential segments, wherein the selected in-game action is associated with a first one of the segments.

5. The method of claim 1, wherein selecting the in-game action further includes identifying a point of action within the current session, and further generating a presentation parameter for synchronizing the presentation of the custom assistive content to the identified point of action.

6. The method of claim 1, further comprising identifying the at least one objective has been met in the current session, and generating updated custom assistive content based on the identification as to whether the at least one objective has been met.

7. The method of claim 6, wherein the at least one objective is identified as not having been met, and wherein generating the updated custom assistive content includes identifying one or more differences between user performance of the selected in-game action and modeled performance of the selected in-game action.

8. The method of claim 1, wherein generating the custom assistive content is further based on one or more characteristics of the user.

9. The method of claim 1, wherein selecting the in-game action includes applying a machine learning model to the user information, and wherein the machine learning model is trained to identify actions correlated with advancement towards the objectives.

10. The method of claim 9, further comprising training the machine learning model based on session data from a plurality of past sessions, each session including a plurality of different actions, wherein the session data for each action is labeled in accordance with metadata regarding an associated outcome.

11. The method of claim 10, wherein one of more of the past sessions are bot sessions in which a bot is programmed to play through the interactive content title in accordance with different sets of actions and conditions.

12. The method of claim 1, wherein the user information includes one or more conditions associated with the current session, and wherein generating the custom assistive content includes filtering a plurality of available media files associated with the selected in-game action based on the conditions.

13. The method of claim 1, wherein the one or more media files includes at least one file that includes user-generated content depicting performance of the selected in-game action during a past session that resulted in completion of the at least one objective.

14. The method of claim 1, further comprising querying the user regarding the plurality of different action options associated with generating the custom assistive content, wherein generating the custom assistive content is further based on one or more query responses.

15. The method of claim 1, further comprising:
updating the progress level toward the at least one of the objectives in real-time during the current session, wherein the updated progress level is predicted to result in failure to complete the at least one objective; and
generating updated custom assistive content that includes a comparison of performance of the selected in-game action associated with failure with performance of the selected in-game action associated with completion of the at least one objective.

16. The method of claim 1, further comprising:
receiving annotation information in association with the user information;
labeling the user information in accordance with the annotation information; and
storing the labeled user information in a repository in memory, wherein the labeled user information is used to construct or train one or more future learning models.

17. The method of claim 16, further comprising generating a user interface for receiving the annotation information, wherein the user interface is associated with one or more input options for capturing and recording the annotation information.

18. A system for generating assistive content, comprising:
a communication interface that communicates over a communication network with a user device, wherein the communication interface receives user information regarding one or more interactions in a virtual environment during a current session of an interactive content title; and
a processor that executes instructions stored in memory, wherein the processor executes the instructions to:
identify that one or more of the interactions correspond to a progress level in relation to one or more objectives associated with the interactive content title;
select an in-game action from among a plurality of different action options to take next within the virtual environment during the current session based on the progress level, wherein the selected in-game action is predicted to result in an outcome that advances the progress level toward at least one of the objectives; and
generate custom assistive content based on the selected in-game action, wherein generating the custom assistive content is based on one or more media files associated with the predicted outcome, wherein the communication interface further provides the custom assistive content over the communication network to the user device for presentation during the current session.

19. The system of claim 18, further comprising memory of one or more databases that store a plurality of media files including the one or more media files associated with the predicted outcome.

20. A non-transitory, computer-readable storage medium, having embodied thereon a program executable by a processor to perform a method for generating assistive content, the method comprising:
receiving user information over a communication network from a user device, the user information regarding one or more interactions in a virtual environment during a current session of an interactive content title;
identifying that one or more of the interactions correspond to a progress level in relation to one or more objectives associated with the interactive content title;
selecting an in-game action from among a plurality of different action options to take next within the virtual environment during the current session based on the progress level, wherein the selected in-game action is predicted to result in an outcome that advances the progress level toward at least one of the objectives;
generating custom assistive content based on the selected in-game action, wherein generating the custom assistive content is based on one or more media files associated with the predicted outcome; and
providing the custom assistive content over the communication network to the user device for presentation during the current session.
